(19) United States
(12) Patent Application Publication
(10) Pub. No.: US 2016/0185623 A1
(43) Pub. Date: Jun. 30, 2016

(54) ULTRAVIOLET STERILIZATION DEVICE

(71) Applicant: ASAHI ORGANIC CHEMICALS INDUSTRY CO., LTD., Nobeoka-shi, Miyazaki (JP)

(72) Inventor: Toshihiro Hanada, Nobeoka-shi, Miyazaki (JP)

(21) Appl. No.: 14/907,424

(22) PCT Filed: Aug. 5, 2014
(86) PCT No.: PCT/JP2014/070600

§ 371 Date: Jan. 25, 2016

(30) Foreign Application Priority Data
Aug. 8, 2013 (JP) 2013-165383

(51) Int. Cl. C02F 1/32

(52) U.S. Cl. CPC C02F 1/325; C02F 2201/324; C02F 2303/04; C02F 2201/322

(57) ABSTRACT

The present invention pertains to an ultraviolet sterilization device (1) for irradiating with ultraviolet light a fluid flowing through a flow passage (6) having an inlet opening (4) and an outlet opening (5), and sterilizing the fluid. The ultraviolet sterilization device is equipped with a light guide (2) formed to tubular shape, and having a flow passage inside, as well as having a light scattering means (8) on the outside peripheral surface, and an ultraviolet light source (3) arranged on the outside surface of the light guide, for irradiating the light guide with ultraviolet light. Ultraviolet light from the ultraviolet light source irradiating the light guide is scattered by the light scattering means, and irradiates the flow passage through the inside peripheral surface of the light guide.

### TECHNICAL FIELD

The present invention relates to an ultraviolet sterilization device which carries out sterilization or decomposition of bacteria, algae, impurities, etc. which are contained in a fluid to be processed by irradiation of ultraviolet rays so as to purify the fluid.

### BACKGROUND ART

In the past, as an ultraviolet sterilization device which is attached in the middle of a pipe and which carries out sterilization or photolysis of bacteria, algae, impurities, etc. contained in the fluid flowing through the pipe by irradiation of ultraviolet rays so as to purify the fluid, there has been the ultraviolet sterilization device 101 shown in FIG. 4 (for example, see PTL 1). The ultraviolet sterilization device 101 is provided with a tube 102 which conveys a fluid to be processed, ultraviolet light sources 103 which are arranged at the inner circumferential surface of the tube 102 for irradiating the fluid with ultraviolet rays, and a control means 104 for controlling the operation of the ultraviolet light sources 103. As the ultraviolet light sources 103, light emitting diodes which emit ultraviolet light (referred to as UV-LEDs, below) are used. In the control means 104, a control method which causes the ultraviolet light sources 103 to pulse by a preselected cycle is used. By arranging the ultraviolet light sources 103 at the inner circumferential surface of the tube 102, the ultraviolet sterilization device 101 can treat the fluid to be processed in-line without storing the fluid in a water tank etc. Further, by controlling the ultraviolet light sources 103 by the control means 104, the ultraviolet sterilization device 101 can effectively irradiate the fluid to be processed with ultraviolet rays, so that the fluid to be processed can be smoothly sterilized.

### CITATION LIST

### Patent Literature

PTL 1: Japanese Patent Publication No. 2009-532200A

### SUMMARY OF INVENTION

### Technical Problem

However, since the conventional ultraviolet sterilization device 101 directly irradiates the fluid to be processed with ultraviolet rays from the ultraviolet light sources 103 which are arranged at the inner circumferential surface of the tube 102, the range of irradiation per each UV-LED which is an ultraviolet light source 103 is narrow and a large number of UV-LEDs are required. Further, since the inner circumferential surface of the tube 102 has a large number of UV-LEDs arranged at intervals, the intensity of the ultraviolet rays in the tube 102 is not uniform and the sterilizing effect by irradiation of ultraviolet rays is liable to not be uniform. Further, since the large number of UV-LEDs has to be attached one by one to the tube 102, sometimes a long period of time is necessary for the assembly work or maintenance work. Further, since the UV-LEDs are attached with passing through the tube 102, the structure of attachment of the UV-LEDs to the tube 102 is complicated. Not only that, the inner circumferential surface of the tube 102 is easily fouled, so that frequent maintenance work is required for maintaining the sterilizing effect.

The present invention was made in consideration of such a problem in the prior art and has as its object the provision of an inline type ultraviolet sterilization device which can uniformly irradiate a broad range by a smaller number of ultraviolet light sources, which enables easy attachment of the ultraviolet light source to the ultraviolet sterilization device, and which is easy to maintain.

### Solution to Problem

According to the aspect of the invention of claim 1, there is provided an ultraviolet sterilization device which irradiates a fluid which flows through a channel having an inlet opening and an outlet opening with ultraviolet rays to sterilize the fluid, the ultraviolet sterilization device comprising a light guide which is formed in a tubular shape, has the channel at its inside, and has a light scattering means at an outer circumferential surface and an ultraviolet light source which is arranged at an outer surface of the light guide and irradiate the light guide with ultraviolet rays, wherein the ultraviolet rays which are emitted from the ultraviolet light source to the light guide are scattered by the light scattering means and irradiate the channel through an inner circumferential surface of the light guide.

That is, in the aspect of the invention of claim 1, by arranging the ultraviolet light source at the light guide which has the light scattering means, the light guide enables the ultraviolet rays which are emitted from the ultraviolet light source to irradiate the fluid not locally like in points but uniformly over a broad range like surfaces. Further, the light guide has the function of a pipe which conveys the fluid to be processed by forming the light guide into a tubular shape. By configuring the device in this way, since it is possible to uniformly irradiate the channel in which the fluid to be processed flows with ultraviolet rays from the inner circumferential surface of the light guide overall or over a broad range, according to the aspect of the invention of claim 1, it is possible to effectively sterilize the fluid to be processed.

As the mechanism for uniformly irradiating a broad range like a surface with ultraviolet rays, first, ultraviolet rays are emitted from the ultraviolet light source to the light guide, the ultraviolet rays are scattered by the light scattering means formed at the outer circumferential surface of the light guide, and then the scattered ultraviolet rays irradiate the channel which is formed at the inside of the light guide through the inner circumferential surface of the light guide. At this time, the ultraviolet rays which are emitted from the ultraviolet light source is scattered by the light scattering means, so that the range of irradiation of ultraviolet rays per ultraviolet light source can be broadened. For this reason, the number of ultraviolet light sources (for example, the number of UV-LEDs) can be smaller. Further, the ultraviolet rays scattered by the light scattering means irradiate the channel from the inner circumferential surface of the light guide by a uniform intensity, so that the sterilizing effect by the ultraviolet rays can be uniform.

Further, since the range of irradiation of ultraviolet rays per ultraviolet light source can be broader, the number of ultraviolet light sources (for example, the number of UV-LEDs) can be reduced, so that the assembly work and maintenance work are easier. Further, since the ultraviolet light source is arranged at the outer surface of the light guide, when the ultraviolet light source is attached to the light guide, there is no need to consider the water-tightness between the ultraviolet light source and light guide, or fouling or breakage of the ultraviolet light source due to the ultraviolet light source being exposed at the inner circumferential surface of the light guide. Therefore, the ultraviolet light source can be attached to the light guide by a configuration easy in terms of assembly work or maintenance work, and maintenance is possible in the state connecting the ultraviolet sterilization device to a pipe. Further, since the ultraviolet light source is not exposed to the inner circumferential surface of the light guide, the inner circumferential surface of the light guide, that is, the surface of the channel, can be made a smooth surface without a surface relief. Therefore, no dead spaces are formed at the channel surface and thus fouling buildup is prevented, and the sterilizing effect by ultraviolet rays can be sustained for a long period of time, so that the frequency of maintenance can be reduced.

According to the aspect of the invention of claim 2, there is provided the ultraviolet sterilization device according to claim 1, wherein the ultraviolet light source is arranged at least at one end face of an inlet opening side or outlet opening side of the light guide.

That is, in the aspect of the invention of claim 2, by arranging the ultraviolet light source at an end face of the light guide, it is possible to arrange the ultraviolet light source concentrated in a limited range, so that the assembly work and the maintenance work are further easier.

According to the aspect of the invention of claim 3, there is provided the ultraviolet sterilization device according to claim 1, wherein the ultraviolet light source is arranged at the outer circumferential surface of the light guide along the channel axial direction.

That is, in the aspect of the invention of claim 3, by arranging the ultraviolet light source at the outer circumferential surface of the light guide along the channel axial direction, there is provided an ultraviolet sterilization device which can effectively sterilize a fluid, even if the length of the light guide along the channel axial direction becomes longer.

In the present invention, the “outer surface of the light guide” is the surface which appears at the outside of the light guide. In the outer surface, the surface extending around the channel of the light guide in the longitudinal direction, that is, the direction of flow (channel axial direction), is the “outer circumferential surface”, while the face positioned at the end of the inlet opening side or outlet opening side of the light guide is an “end face”. Further, the “inner circumferential surface of the light guide” is the surface which appears at the inside of the light guide and is the surface forming the channel which extends in the longitudinal direction of the light guide, that is, the direction of flow. Further, the “inside of the light guide” is the inside of the main body forming the light guide, that is, the inside of the light guide is the hollow part of the light guide forming the channel.

### Advantageous Effects of Invention

According to the aspects of the invention of claim 1 to claim 3, it is possible to provide an inline type ultraviolet sterilization device which can uniformly irradiate a broad range by a smaller number of ultraviolet light sources, which enables easy attachment of the ultraviolet light source to the ultraviolet sterilization device, and which is easy in maintenance.

### BRIEF DESCRIPTION OF THE DRAWINGS

FIG. 1 is a longitudinal section view which shows an ultraviolet sterilization device according to a first embodiment of the present invention.

FIG. 2 is a longitudinal section view which shows an ultraviolet sterilization device according to a second embodiment of the present invention.

FIG. 3 is a perspective view which shows an ultraviolet sterilization device according to a third embodiment of the present invention.

FIG. 4 is a longitudinal section view which shows a conventional ultraviolet sterilization device.

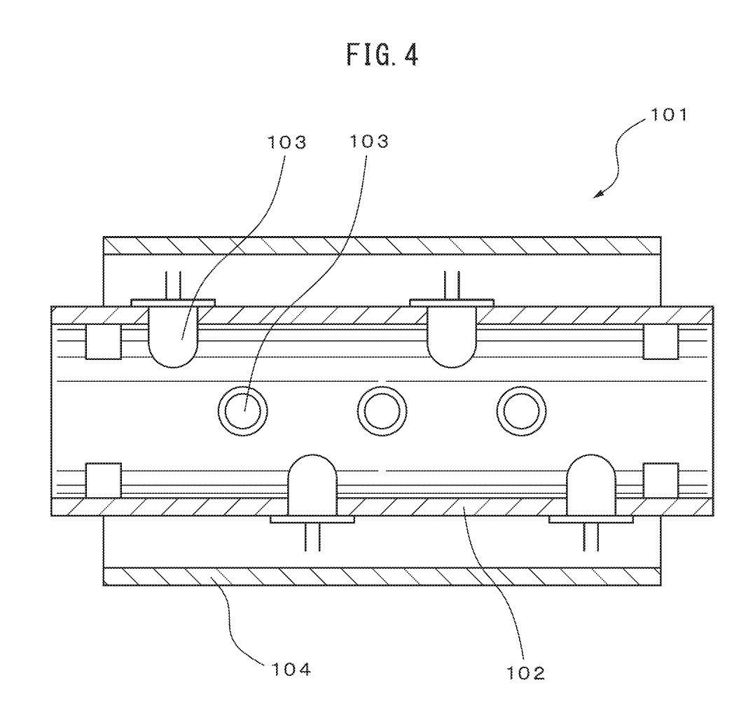

### DESCRIPTION OF EMBODIMENTS

Below, embodiments of the present invention will be explained with reference to the embodiments shown in the drawings, however the present invention is not limited to the following embodiments needless to say.

### First Embodiment

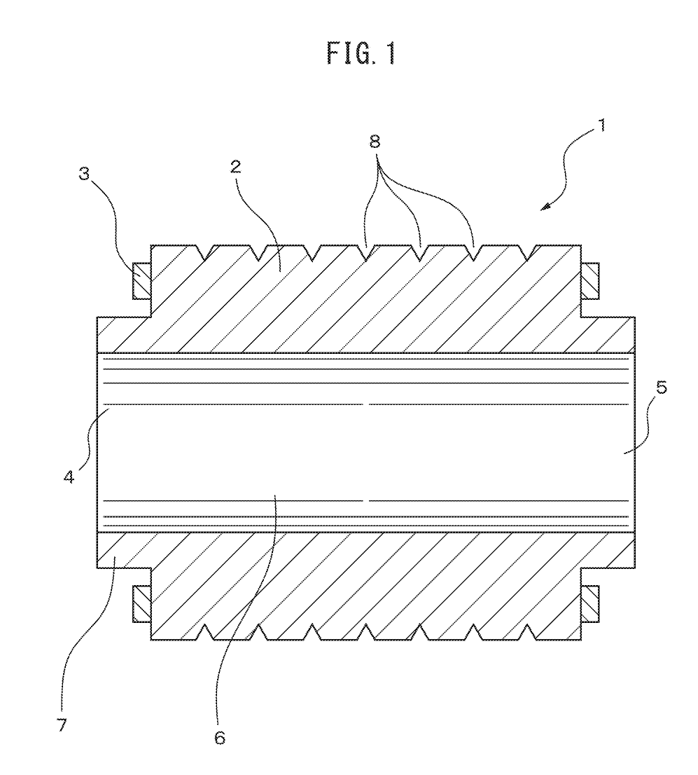

Below, referring to FIG. 1, an ultraviolet sterilization device 1 according to a first embodiment of the present invention will be explained. FIG. 1 is a longitudinal section view which shows the ultraviolet sterilization device 1 according to the first embodiment. This ultraviolet sterilization device 1 is provided with a light guide 2 which is formed into a tubular shape and ultraviolet light sources 3 which are arranged at the outer surface of the light guide 2.

In the first embodiment, the light guide 2 is made of a polymethyl methacrylate and is formed in a round tubular shape. One of the end faces of the light guide 2 is formed with an inlet opening 4, while the other end face is formed with an outlet opening 5. At the inside of the light guide 2, a channel 6 through which water, air or another fluid to be processed containing organic matter, microorganisms, etc. (for example, sewage) is formed in a straight shape. At the two end faces of the light guide 2, ultraviolet light sources 3 are arranged. The outer circumferential surface of the light guide 2 is formed with the light scattering means 8. At the two end parts of the light guide 2, tubular shaped connecting parts 7 are formed for connecting pipes at the upstream and downstream sides of the light guide 2 to the light guide 2.

In the present invention, the material of the light guide 2 need only be one which allows the passage of the ultraviolet rays which are emitted from the ultraviolet light sources 3 and is not particularly limited. For example, one made of polymethyl methacrylate, polycarbonate, polypropylene, polyethylene fluoride, polyvinylidene fluoride, polymethyl pentene, quartz glass, multicomponent glass, and combinations of these, etc., may be mentioned.

Referring to FIG. 1, the light guide 2 is formed to a round tubular shape, however the shape of the light guide 2 need only be a tubular shape and is not particularly limited. As the shape of the light guide 2, for example, a round tubular shape, angular tubular shape, and combinations of these, etc., may be mentioned. Further, in the first embodiment, the connecting part 7 is formed to a tubular shape. However, the shape or connection manner of the connecting part 7 is not particularly limited. As the shape or connection manner of the connecting part 7, for example, a socket shape, flange shape, screw shape, etc., may be mentioned as suitable. Further, the connecting part 7 may be formed integrally with the light guide 2 or may be formed separately therefrom, which is not particularly limited.

In the first embodiment, the ultraviolet light sources 3 are arranged at the two end faces of the light guide 2. At the respective end faces, four UV-LEDs are arranged in the circumferential direction at predetermined intervals. The type or wavelength of the ultraviolet light sources 3 can be suitably selected by the object of use of the ultraviolet sterilization device 1. As an ultraviolet light source 3, in addition to the UV-LEDs, an ultraviolet ray lamp, excimer laser, etc., may be mentioned as suitable. Further, as the wavelength of the ultraviolet rays, in consideration of the sterilizing effect, a source which emits ultraviolet rays of a wavelength of between 150 to 400 nm, preferably 200 to 400 nm is suitable. Further, different types or different wavelengths of ultraviolet light sources 3 may be simultaneously used. Note that, in the first embodiment, ultraviolet light sources 3 are arranged the two end faces of the light guide 2. However, they may also be arranged at just one end face of the inlet opening 4 side or outlet opening 5 side or may be arranged at the outer circumferential surface of the light guide 2. That is, the ultraviolet light sources 3 may be arranged at any locations of the outer surface of the light guide 2 so long as the ultraviolet sterilization device 1 exhibits the operations shown below.

The light scattering means 8 is one which can scatter the ultraviolet rays which are emitted from the ultraviolet light sources 3 to the light guide 2 and irradiate the fluid to be processed by the ultraviolet rays through the inner circumferential surface of the light guide 2. In the first embodiment, the light scattering means 8 is comprised of a plurality of light scattering grooves which are formed at the outer circumferential surface of the light guide 2. Referring to FIG. 1, the light scattering grooves are V-cross-section ring-shaped grooves and are formed so as to be able to make the scattered ultraviolet rays uniformly irradiate the channel 6 from the inner circumferential surface of the light guide 2. By forming the light scattering grooves in this way, ultraviolet rays can more uniformly irradiate the channel 6. The method of formation of the light scattering grooves is not particularly limited. However, machining, laser cutting, shaping using dies, etc., may be mentioned as suitable methods of formation thereof. Further, in the first embodiment, the light scattering means 8 is formed from a plurality of light scattering grooves. However, the means need only be able to scatter the ultraviolet rays and is not particularly limited.

Next, the operation of the ultraviolet sterilization device 1 according to the first embodiment of the present invention will be explained.

When ultraviolet rays irradiate the light guide 2 from the ultraviolet light sources 3, the ultraviolet rays proceed through the inside of the light guide 2 and reach the light scattering means 8. The ultraviolet rays which reach the light scattering means 8 are scattered by the light scattering means 8, through the inner circumferential surface of the light guide 2, and irradiate the fluid to be processed which flows through the channel 6. At this time, by scattering the ultraviolet rays which are emitted from the ultraviolet light sources 3 by the light scattering means 8, it is possible to irradiate a broad range with ultraviolet rays even by a smaller number of ultraviolet light sources 3. Further, by causing the ultraviolet rays to scatter, the channel 6 can be irradiated by the ultraviolet rays through the inner circumferential surface of the light guide 2 over a broad range by a uniform intensity, so that the sterilizing effect of the ultraviolet rays on the fluid to be processed can be made uniform.

Further, since the ultraviolet light sources 3 are arranged at the outer surface of the light guide 2, and the ultraviolet light sources 3 are not exposed at the inner circumferential surface of the channel 6 and no dead spaces are created, the inner circumferential surface of the channel 6 and the surfaces of the ultraviolet light sources 3 can be prevented from being fouled. Therefore, the channel surface becomes resistant to fouling and the ultraviolet sterilizing effect can be maintained for a long period, so that the number of times of maintenance can be decreased. Further, since the ultraviolet light sources 3 are arranged at the outside of the light guide 2, when arranging the ultraviolet light sources 3 at the light guide 2, there is no need to worry about the leakage of the fluid to be processed between the ultraviolet light sources 3 and the light guide 2 and about damage to the ultraviolet light sources 3, etc., as well as assembly work and maintenance work of the ultraviolet light sources 3 can be made easy.

### Second Embodiment

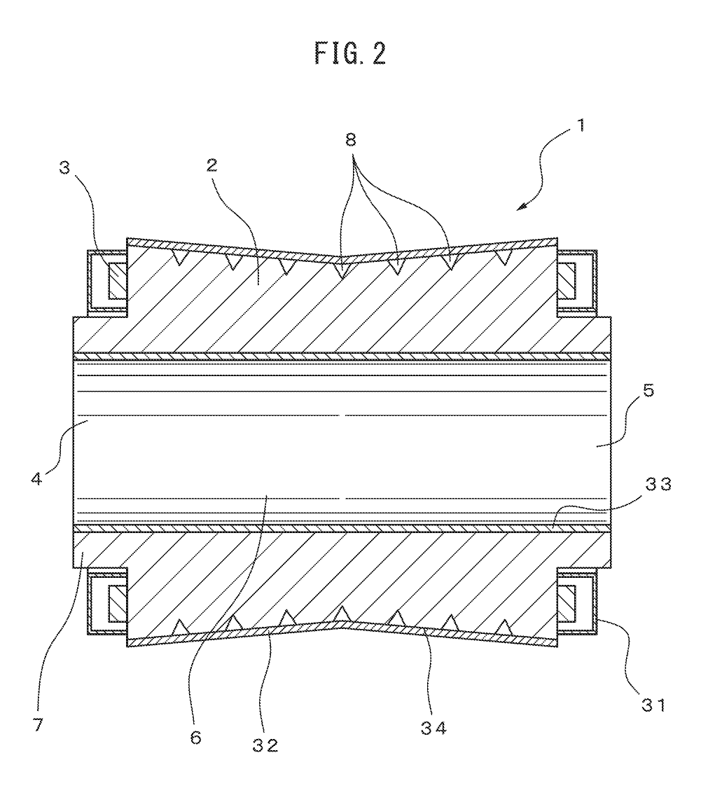

Below, referring to FIG. 2, an ultraviolet sterilization device 1 according to a second embodiment of the present invention will be explained. FIG. 2 is a longitudinal section view which shows an ultraviolet sterilization device 1 according to the second embodiment. The points by which the second embodiment differs from the first embodiment are mainly the configurations of the light source side reflecting means 31, light scattering means side reflecting means 32 and light diffusing means 33. Note that, in FIG. 2, components which have similar operations or functions as the first embodiment are assigned the same reference notations as in FIG. 1. Below, mainly the difference from the first embodiment will be explained.

The ultraviolet sterilization device 1 is provided with a light guide 2 and ultraviolet light sources 3 which are arranged at two end faces of the light guide 2. The light guide 2 is formed into a round tubular shape. At the inside of the light guide 2, a channel 6 is formed, while at the outer circumferential surface thereof, a light scattering means 8 is formed. Further, in the second embodiment, a taper part 34 is formed so that the outside diameter decreases from end faces of the light guide 2 toward the center part in the longitudinal direction of the light guide 2. That is, the shortest distance between the outer circumferential surface at which the light scattering means 8 is formed and the channel 6 (inner circumferential surface of the light guide 2) becomes shorter the further from the ultraviolet light sources 3.

Referring to FIG. 2, at the outside of the ultraviolet light sources 3, a light source side reflecting means 31 is provided for preventing leakage of ultraviolet rays to the outside of the light guide 2 and guiding the ultraviolet rays which do not directly irradiate the light guide 2 to the light guide 2. In the second embodiment, an U-cross-section ring-shaped member made of aluminum is used as the light source side reflecting means 31. The light source side reflecting means 31 need only reflect ultraviolet rays and is not particularly limited in material, shape, etc. As the light source side reflecting means 31, for example, one made of aluminum or another material which reflects ultraviolet rays or a plastic or other hard material on which a silvered film, polyester sheet, or other thin film which reflects ultraviolet rays is attached may be used. Further, the respective ultraviolet light sources 3 may be individually provided with light source side reflecting means 31.

In the second embodiment, the outer circumferential surface of the light guide 2 is formed with the light scattering means 8. Furthermore, a light scattering means side reflecting means 32 is provided at the outside of the light scattering means 8. The light scattering means side reflecting means 32 is provided to prevent ultraviolet rays from leaking from the surface where the light scattering means 8 is formed to the outside of the light guide 2 and to make the ultraviolet rays to be leaked to the outside of the light guide 2 to the inner circumferential surface of the light guide 2. In the second embodiment, an aluminum plate is used as a light scattering means side reflecting means 32. The light scattering means side reflecting means 32 is not particularly limited in material, shape, etc., so long as able to reflect ultraviolet rays. As the light scattering means side reflecting means 32, a polyester sheet, aluminum plate, silvered film, etc., may be mentioned.

Referring to FIG. 2, the inner circumferential surface of the light guide 2 is provided with a light diffusing means 33 for more uniformly irradiating a fluid to be processed with ultraviolet rays which are scattered by the light scattering means 8. In the second embodiment, a polymethyl methacrylate sheet which is treated for diffusion may be closely attached for use as a diffusing means. As the material of the sheet of the light diffusing means 33, polyester, polycarbonate, polypropylene, polyethylene fluoride, polyvinylidene fluoride, polymethyl pentene, etc., may be mentioned. Further, even if not using a sheet, the inner circumferential surface of the light guide 2 may be treated for diffusion in advance.

Next, the operation of the ultraviolet sterilization device 1 according to the second embodiment of the present invention will be explained.

When ultraviolet rays are emitted from the ultraviolet light sources 3 toward the light guide 2, a part of the ultraviolet rays does not directly irradiate the light guide 2. Here, the ultraviolet rays which do not directly irradiate the light guide 2 are reflected by the light source side reflecting means 31 and thereby irradiate the light guide 2. The ultraviolet rays which enter the light guide 2 reach the light scattering means 8 and are scattered by the light scattering means 8. Here, the outer circumferential surface of the light guide 2 is formed with the taper part 34, and therefore can effectively scatter the ultraviolet rays.

Part of the ultraviolet rays which reach the light scattering means 8 leaks from the surface at which the light scattering means 8 is formed to the outside of the light guide 2. Here, the ultraviolet rays which leak to the outside of the light guide 2 are reflected by the light scattering means side reflecting means 32 and irradiate the inner circumferential surface of the light guide 2. By providing the light source side reflecting means 31 and light scattering means side reflecting means 32 in this way, it is possible to prevent the leakage of ultraviolet rays to the outside of the light guide 2, so that it is possible to effectively irradiate the fluid to be processed which flows through the channel 6 at the inside of the light guide 2 by ultraviolet rays from the inner circumferential surface of the light guide 2. Here, if the inner circumferential surface of the light guide 2 is provided with the light diffusing means 33, the ultraviolet rays which are scattered by the light scattering means 8 can more uniformly irradiate the fluid to be processed.

### Third Embodiment

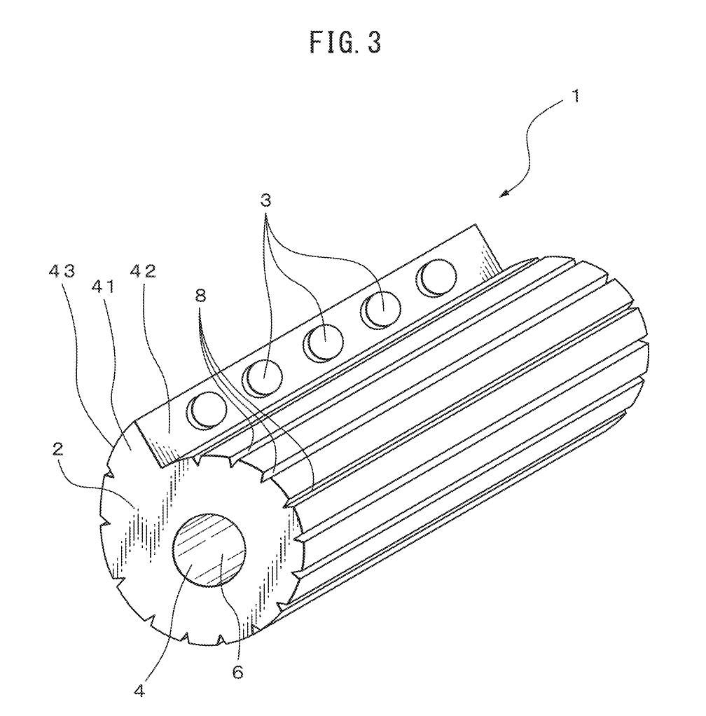

Below, referring to FIG. 3, an ultraviolet sterilization device 1 according to a third embodiment of the present invention will be explained. FIG. 3 is a perspective view which shows an ultraviolet sterilization device 1 according to a third embodiment. The point on which the third embodiment differs from the first embodiment is mainly the arrangement of the ultraviolet light sources 3. That is, in the third embodiment, the ultraviolet light sources 3 are arranged at the outer circumferential surface of the light guide 2 along the channel axial direction. Note that, in FIG. 3, components which have similar operations or functions as the first embodiment are assigned the same reference notations as in FIG. 1. Below, mainly the difference from the first embodiment will be explained.

The ultraviolet sterilization device 1 is provided with a light guide 2 and ultraviolet light sources 3. The light guide 2 is formed into a round tubular shape. At the inside of the light guide 2, a channel 6 is formed, while at the outer circumferential surface thereof, a light scattering means 8 is formed. Further, at the outer circumferential surface of the light guide 2, a ridge part 41 which is formed in a straight line shape along the channel axial direction of the light guide 2 is formed as a seat for arranging the ultraviolet light sources 3. The two end faces of the ridge part 41 are formed on the same planes as the two end faces of the inlet opening 4 and outlet opening (not shown) of the light guide 2. The ridge part 41 includes a flat part 42 formed from a flat surface and a curved part 43 formed from a curved surface which is smoothly connected to the outer circumferential surface of the light guide 2. The flat part 42 and curved part 43 extend in the channel axial direction. The ultraviolet light sources 3 are arranged on the flat part 42 of the ridge part 41 of the light guide 2.

Referring to FIG. 3, the ridge part 41 is formed in a straight line along the channel axial direction of the light guide 2, however it may be formed in any shape so long as enabling ultraviolet light sources 3 to be arranged at the outer circumferential surface of the light guide 2 along the channel axial direction, and it is not particularly limited. For example, the ridge part 41 may be formed in a spiral shape centered about the axis of the channel or another axis substantially parallel to the axis of the channel. Further, in the third embodiment, the ultraviolet light sources 3 are arranged at the ridge part 41 which is formed at the light guide 2, however the part where the ultraviolet light sources 3 are arranged need not stick out and is not particularly limited. For example, the light guide 2 may be formed with a groove part and may have ultraviolet light sources 3 arranged in them. Further, the light guide 2 may be formed with a plurality of recessed parts and have ultraviolet light sources 3 arranged in them. Further, in the third embodiment, a plurality of disk shaped ultraviolet light sources 3 are arranged at the ridge part 41. However, the shape and number of the ultraviolet light sources 3 are not particularly limited. For example, it is also possible to arrange just one straight tubular shaped ultraviolet light source 3 having substantially the same length as the light guide 2. Further, since the operation of the ultraviolet sterilization device 1 according to a third embodiment is similar to the first embodiment, the explanation of the operation thereof will be omitted.

In the present invention, a plurality of ultraviolet sterilization devices 1 may be connected in series. By connecting in series a plurality of ultraviolet sterilization devices 1, it is possible to lengthen the treatment time of a fluid to be processed. At this time, the wavelengths, etc., of the ultraviolet light sources 3 of the ultraviolet sterilization devices 1 can be changed.

Note that, the first embodiment and the third embodiment can be arbitrarily combined to form the ultraviolet sterilization device 1. That is, so long as the characteristics and functions of the present invention can be realized, the present invention is not limited to the ultraviolet sterilization device 1 of the embodiments.

### REFERENCE NOTATIONS LIST

1. ultraviolet sterilization device
2. light guide
3. ultraviolet light source
4. inlet opening
5. outlet opening
6. channel
7. connecting part
8. light scattering means
31. light source side reflecting means
32. light scattering means side reflecting means
33. light diffusing means
41. ridge part

1. An ultraviolet sterilization device which irradiates a fluid which flows through a channel having an inlet opening and an outlet opening with ultraviolet rays to sterilize the fluid, the ultraviolet sterilization device comprising:
a light guide which is formed in a tubular shape, has the channel at its inside, and has a light scattering means at an outer circumferential surface; and
an ultraviolet light source which is arranged at an outer surface of the light guide and irradiate the light guide with ultraviolet rays,
wherein the ultraviolet rays which are emitted from the ultraviolet light source to the light guide are scattered by the light scattering means and irradiate the channel through an inner circumferential surface of the light guide.

2. The ultraviolet sterilization device according to claim 1, wherein the ultraviolet light source is arranged at least at one end face of an inlet opening side or outlet opening side of the light guide.

3. The ultraviolet sterilization device according to claim 1, wherein the ultraviolet light source is arranged at the outer circumferential surface of the light guide along the channel axial direction.
